(19) United States
(12) Patent Application Publication
(10) Pub. No.: US 2012/0319441 A1
(43) Pub. Date: Dec. 20, 2012

(54) STRUCTURE FOR AIRCRAFT SEAT SECTION

(75) Inventor: Kenji Uegaki, Susono-shi Shizuoka (JP)

(73) Assignee: TOYOTA JIDOSHA KABUSHIKI KAISHA, Toyota-shi Aichi-ken (JP)

(21) Appl. No.: 13/578,507

(22) PCT Filed: Mar. 12, 2010
(86) PCT No.: PCT/JP2010/054239

§ 371 Date: Aug. 10, 2012

(51) Int. Cl. B64D 11/06; B60N 2/42

(52) U.S. Cl. 297/216.1

(57) ABSTRACT

An object of the invention is to provide a structure for an aircraft seat section is configured to be able to have an appropriate impact absorbing stroke in an aircraft having a small interior space. The structure is provided with a survival tub (1) which is an occupant protection member for surrounding from the lower side of the aircraft body, the space for an occupant (51) which includes a seat (50) on which the occupant sits. Preferably, the survival tub (1) is held by link mechanisms (4, 5) and an impact absorption operation section (9) so that during impact, the survival tub (1) can move to the upper side of the aircraft body.

### TECHNICAL FIELD

The present invention relates to a structure for an aircraft seat section and, specifically, to a structure for a seat section to protect occupants during an impact.

### BACKGROUND ART

For the structure of an aircraft seat section, the strength of a seat is defined in FAR (Federal Aviation Regulations) 23.562, however, a structure for an aircraft body including a seat is not regulated therein. Since aircraft are operated at high speeds, the impact speeds thereof are more than double that of an automobile or a railway vehicle and the required amount of energy for absorbing an impact involving an aircraft is equal to four times or greater than for these. On the other hand, compared with the automobiles and railway vehicles, lightness of weight and compactness of the aircraft body are strongly demanded in aircraft, and the amount of the absorption stroke is difficult to secure during impact.

Thus, a seat structure has been proposed to effectively absorb an impact with a small stroke amount and thereby to protect the occupants. A technique described in patent literature 1 discloses an example of such a technique and is configured so that a floor board and a lower portion of a seat in a rotary-wing aircraft separate and when a predetermined landing impact load is applied, both of them are separated to lower the lower portion of the seat and thereby the impact on the occupant is reduced by impact absorption means arranged at the lower portion of the seat.

### CITATION LIST

### Patent Literature

[Patent Literature 1] JP 2006-232075 A

### SUMMARY OF INVENTION

### Technical Problem

The technique described in patent literature 1 secures the impact absorbing stroke at the lower portion of the aircraft body, at which major configuration members are not present because the target is a rotary wing aircraft which has rotary wings located at the upper portion of the aircraft body. However, since a solid main spar is arranged under the occupant seat in case of the low wing type small aircraft among the fixed-wing aircrafts, it is difficult to secure the impact absorbing stroke with the same method as described above.

It is an object of the invention is to provide a structure for an aircraft seat section that can secure a proper impact absorbing stroke even which aircraft having a narrow interior space.

### Solution to Problem

To solve the problems described above, according to an aspect of the invention, there is provided a structure for an aircraft seat section which includes an occupant protection member which covers an occupant space including the seat from the lower side of an aircraft body. The structure may further include moving means which moves the occupant protection member to the upper side of the aircraft body during impact. The moving means may include support means which supports the side of the occupant protection member at the front side of the aircraft body to be rotatable about an axis substantially parallel with the left and right axis of the aircraft body as a centre, and stretching means which holds the rear side of the aircraft body of the occupant protection member to be movable in the vertical direction of the aircraft body, and the stretching means may absorb the impact through a process of contraction.

The structure for the aircraft seat section may further include a vertical wall which is arranged at an end of the occupant protection member in the width direction of the aircraft body and an impact absorption member which is arranged at the side portion of the aircraft body adjacent to the vertical wall. Alternatively, the structure for the aircraft seat section may further include an aircraft body structure member which is arranged to connect to the lower side of the aircraft body of the occupant protection member and changing means which changes the length of the aircraft body structure member in the vertical direction of the aircraft body.

### Advantageous Effects of Invention

According to the invention, since the occupant space including seats is covered by the occupant protection member from the lower side of the aircraft body, the occupant protection space is secured and thereby the occupant can be reliably protected during a landing impact, due to such as a crash.

The occupant protection member moves to the upper side of the aircraft body during impact and thereby sufficient impact absorption stroke can be secured even in a small space and furthermore, the impact with respect to the occupant can be reduced. The support means and the stretching means described above are assembled and thereby the occupant protection member including the seat portion can be appropriately moved to the upper side of the aircraft body. The stretching means absorbs the impact using a process of contraction and thereby collision energy of the secondary collision is absorbed upon being subjected to a secondary collision and the occupant can be further protected.

Also, the impact absorption member is arranged with the structure described above and thereby the impact applied to the aircraft body can be effectively absorbed with the help of stable plastic deforming and the occupant can be further protected.

The length of the aircraft body structure member in the vertical direction of the aircraft body is changed during impact and thereby the impact absorption stroke can be effectively secured and furthermore, the impact with respect to the occupant can be reduced.

### BRIEF DESCRIPTION OF DRAWINGS

FIG. 1 is a side view showing a first embodiment of a structure for an aircraft seat section according to the invention.

FIG. 2 is a cross-sectional view of FIG. 1.

FIG. 3 is a cross-sectional view showing a bottom surface of a modification of FIG. 1.

FIG. 4 is a side view showing a second embodiment of a structure for an aircraft seat section according to the invention.

FIG. 5 is a cross-sectional view taken along line A-A of FIG. 4.

FIG. 6 is an enlarged view of a portion of FIG. 5.

FIG. 7 is a view showing deformation process of the embodiment of FIG. 4 during a collision.

FIG. 8 is a view showing a basic configuration of an impact absorption operation section of a structure for an aircraft seat section according to the invention.

FIG. 9 is a view showing a configuration near an impact absorption operation section of a structure for an aircraft seat section which is configured as a mechanical type.

FIG. 10 is a view showing a configuration to achieve a function of an impact absorber at the impact absorption operation section.

FIG. 11 is a cross-sectional view showing a configuration of a crushing section of a main spar of a main wing of the structure for the aircraft seat section according to the invention.

FIG. 12 is a view of the crushing section of FIG. 11 seen from above.

FIG. 13 is a cross-sectional view of the main spar of the main wing shown in FIG. 12.

FIG. 14 is a cross-sectional view of other portions of the spar the main wing shown in FIG. 12.

FIG. 15 is a cross-sectional view of a modification of a portion corresponding to FIG. 14.

### DESCRIPTION OF EMBODIMENTS

Below, preferred embodiments of the invention are described in detail with reference to attached drawings. For ease of understanding of the description, in each drawing the same reference numbers are applied to the same constituent elements, and duplicated description thereof is omitted.

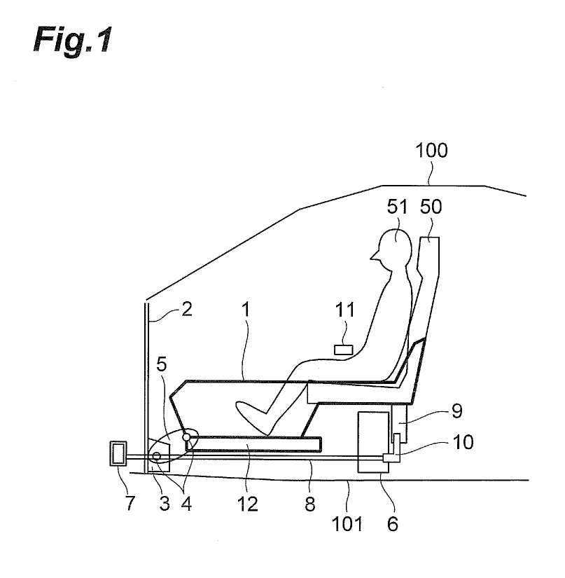

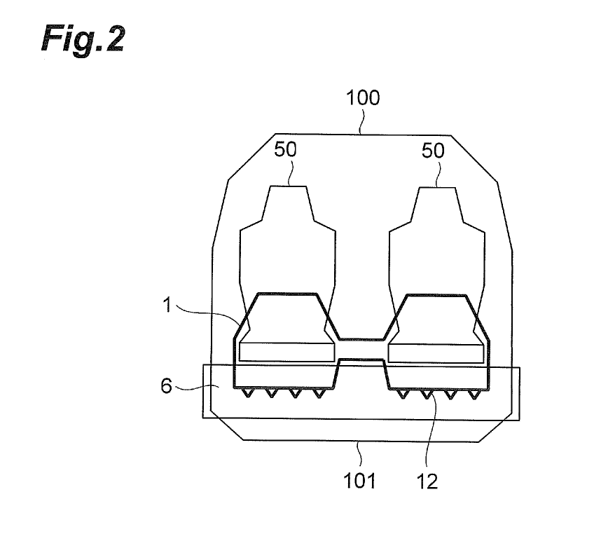

FIG. 1 is a side view showing a first embodiment of a structure for an aircraft seat section according to the invention. FIG. 2 is a cross-sectional view of FIG. 1. The aircraft is a low-wing type small aircraft and an occupant space where the occupants board is disposed to the rear of a firewall 2 surrounded by an upper outer-shell 100 and a lower outer-shell 101 of the aircraft body.

In the occupant space, a survival tub 1 is disposed for each seat 50 and is an occupant protection member to surround the occupant 51 sat on the seat 50 from the lower side thereof. The survival tub 1 is made of FRP (Fiber Reinforced Plastics) or a light metal such as aluminum alloy, duralumin and titanium alloy, and is set to have a collision strength higher than the outer-shells 100 and 101 of an aircraft body section.

A lower end of an aircraft nose side of the survival tub 1 is installed to a sturdy aircraft nose structure member 3 of the lower end of the firewall 2 by a pivot 4 through a link bracket 5. Accordingly, the survival tub 1 is supported to be rotatable around an installation section of the pivot 4 of the aircraft nose structure member 3 as a center and about an axis parallel to the left and right axis of the aircraft body as a center axis. Furthermore, the survival tub 1 may be directly installed to the aircraft nose structure members 3 by the pivot 4 without using the link bracket 5.

The lower end of the survival tub 1 in the rear side end of the aircraft body is connected to the upper end of an impact absorption operation section 9 (described later). The lower end of the impact absorption operation section 9 is connected to a main spar 6 of the main wing, which is a sturdy structural member extending in the left and right directions of the aircraft body, by a mounting section (a mounting section of the impact absorption operation section) 10 thereof. Accordingly, the impact absorption operation section 9 holds the rear end of the survival tub 1 to be movable in the vertical direction of the aircraft body. The impact absorption operation section 9 is connected to a collision detection section 7 arranged under the aircraft nose by a load transmission section 8.

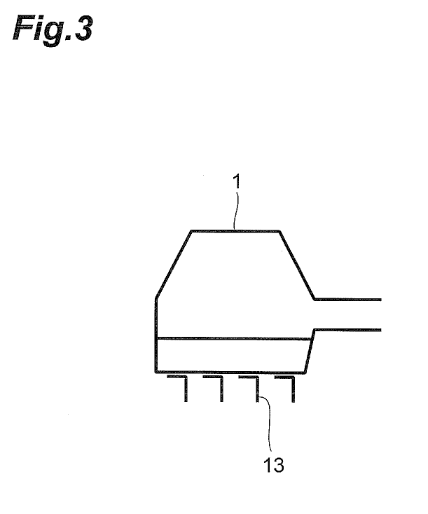

In addition, a bead 12 is disposed on the floor of the survival tub 1. The bead 12 extends in the back and forth direction of the aircraft body and the vertical cross-section thereof is formed in a waveform (a triangle wave in the drawing). Instead of the bead 12, as shown in FIG. 3, a plurality of ribs 13 extending in the back and forth direction of the aircraft body and having L-shaped cross-sections may be arranged.

Also, the seat 50 itself is preferable to have an impact absorbing structure and an air bag 11 may be arranged at the seat belt portion to develop to a space in front of the occupant 51 for protecting the occupant 51 when an impact of a predetermined level or more is applied.

Even if the aircraft body section is separated during a landing impact due to such as a crash, the survival tub 1 moves in the upward direction of the aircraft body and thereby the downward impact absorption stroke of the survival tub 1 is secured. Thus, the bead 12 disposed below the survival tub 1 reduces the impact when the survival tub 1 collides with the ground and a sudden stop of the seat 50 due to the friction between the survival tub 1 and the ground is suppressed and thereby excessive acceleration can be prevented from being applied to the occupant 51 can and the occupant can be protected.

At the time, the airbag 11 described above is operated and expands into the space in front of the occupant 51 so that the occupant 51 can be suppressed against moving in the upward direction of the aircraft body and the occupant 51 can be protected.

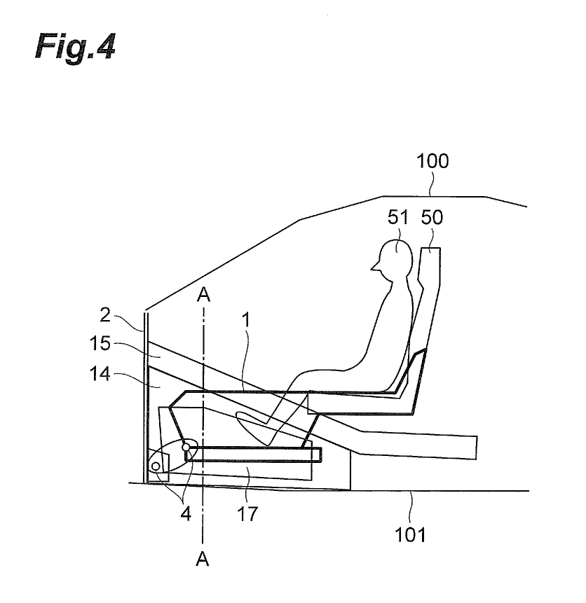

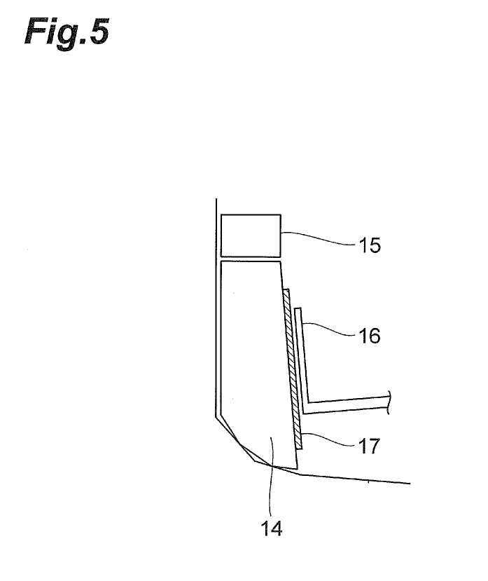

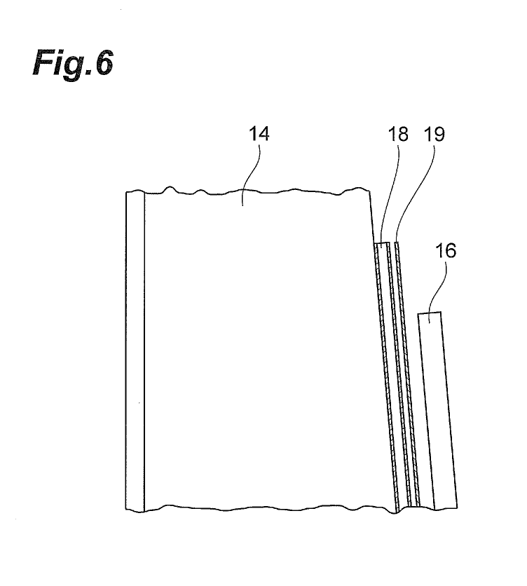

Next, a second embodiment of the structure for the aircraft seat section of the invention is described. FIG. 4 is a side view thereof, FIG. 5 is a cross-sectional view taken along line A-A and FIG. 6 is an enlarged view of a portion thereof. In the embodiment, an aircraft nose lower impact absorption (EA; Energy Absorption) structure 14 is arranged below an aircraft body frame 15 in a form surrounding the survival tub 1. Thus, a sliding plate 17 is arranged at the inner surface of the EA structure 14 and a slight gap is provided between the sliding plate 17 and a sliding vertical wall 16 of side surface of the survival tub 1.

The sliding plate 17 includes a sliding film 19 formed of Teflon (registered trade mark) or the like having low frictional resistance which is affixed to the surface of the sliding vertical wall 16 side of a multilayered plate 18 having high bending rigidity. Contrary to the configuration of FIGS. 5 and 6, the sliding plate 17 may be installed at the sliding vertical wall 16 instead of the EA structure 14 side. In this case, the sliding film 19 may be arranged toward the EA structure 14 side.

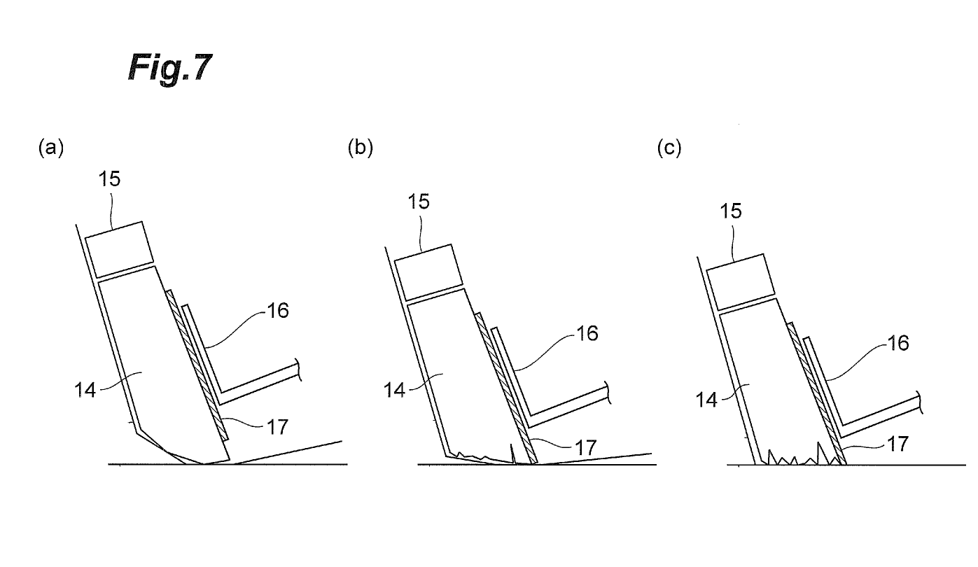

When the aircraft body collides with the ground, a state of a case where the aircraft rolls to the left or right is shown in FIGS. 7(a) to 7(c). FIG. 7(a) shows a state just before the collision, FIG. 7(b) shows a state immediately after the collision and FIG. 7(c) shows a state in which plastic deformation of the aircraft body has progressed. As shown in the drawings, the sliding vertical wall 16 of the survival tub 1 prevents the EA structure 14 from the lateral collapse even upon being subjected to a rolling collision and the EA structure 14 is held to stably undergo plastic deformation and thereby the collision energy is effectively absorbed by the EA structure 14. Accordingly, the legs of the occupant can be protected.

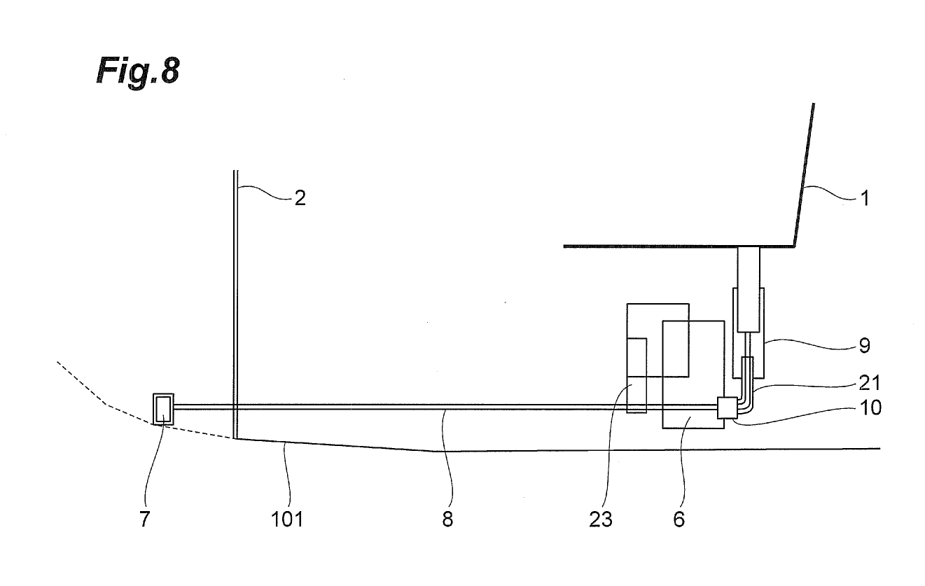

Next, the specific configuration of the impact absorption operation section 9 is described. FIG. 8 is a view showing the basic configuration of the impact absorption operation section of the structure for the aircraft seat section according to the invention. The collision detection section 7 installed at the aircraft nose detects information of the ground collision through the mechanical load, the hydraulic load, electrical signals or the like and transmits the information to the impact absorption operation section 9 through the load transmission section 8. The impact absorption operation section 9 is described in detail later and has both a function of an extending actuator and a function of an impact reducing absorber. The impact absorption operation section 9 is installed at the main spar 6 of the main wing by the operation installation section 10 and the load transmission section 8 changes the extending direction thereof to the impact absorption operation section 9 by a load direction conversion tube 21 to connect to the impact absorption operation section 9. A crushing section 23 (described later) of a main spar of a main wing is installed at the main spar 6 of the main wing.

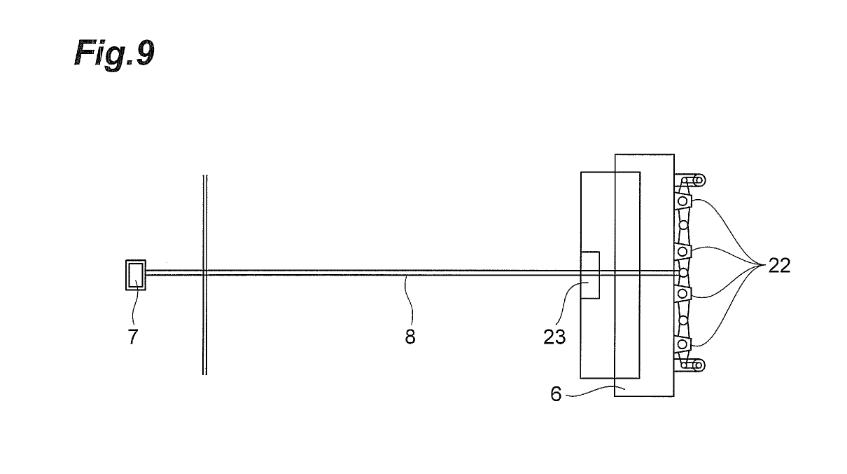

FIG. 9 shows a configuration near the impact absorption operation section 9 that is configured as a mechanical type. When configured as a mechanical type, a distribution link mechanism 22 is disposed between the load transmission section 8 and the load direction conversion tube 21. The load applied to the collision detection section 7 is decelerated and then is delivered to the impact absorption operation section 9. For example, the collision detection section 7 is configured such that the stroke is operated 80 cm at a speed of 40 m/s and stops, and thus the acceleration becomes 200 G by the deceleration time of 0.02 seconds. Meanwhile, when decelerated to 1/10 through the link mechanism 22, the acceleration that lifts the survival tub 1 is suppressed to 20 G. In this case, the lifting amount of the survival tub 1 becomes 8 cm, which is 1/10 thereof.

When configuring the impact absorption operation section 9 as a hydraulic type, cylinder system of the detection section 7 and the operation section 9 may be appropriately set and thereby the conversion of the transmission speed may be performed. When the transmission speed is converted to 1/10 similarly to the mechanical type described above, the cross-sectional area of the cylinder of the operation section 9 may be set to 10 times the cross-sectional area of the detection section 7. The function of the elongating actuator is achieved by the hydraulic cylinder of the operation section 9 and at the same time, a decompression orifice is disposed at the cylinder to achieve the function of the impact reducing absorber.

When configuring the impact absorption operation section 9 in the electric type, the detection section 7 is configured of a potentiometer and the operation section 9 is configured of a driving section where a motor and gears are assembled. An operation voltage or electric power of the motor and the gears, and a gear ratio of the gear section are appropriately set and thereby the transmission speed conversion is performed and the function of the elongating actuator is held.

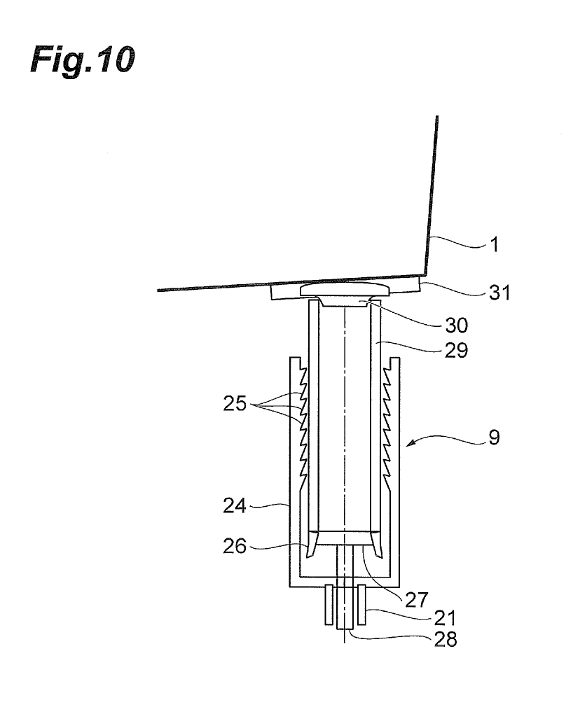

The configuration for achieving the function of the impact absorber in the impact absorption operating division 9 of the mechanical type and the electric type is described with reference to FIG. 10. The impact absorption operation section 9 is configured such that an inner cylinder 27 having the plastic deformation absorbing body 29 configured of composites at the upper end thereof is arranged inside the outer cylinder 24 having hook sections 25 where a plurality of claws are aligned in a saw-toothed shape at the inner surface thereof. A claw 26 configured of an elastic body protruding outwards is disposed at a bottom section (a portion which holds the lower end of the plastic deformation absorbing body 29) of the inner cylinder 27. The outer cylinder 24 is connected to the load direction conversion tube 21, while the inner cylinder 27 is connected to an operating axis section 28. The inner cylinder 27 is held to be movable inside the outer cylinder 24. At the rear lower section of the survival tube 1, a saucer section 30 and a support guide 31 which supports the saucer section 30 are disposed corresponding to the upper end of the inner cylinder 27. The inner cylinder 27 and the saucer section 30 do not need to be connected.

During a landing collision, the operating axis section 28 moves in the upward direction of the aircraft body and thereby the inner cylinder 27 moves the outer cylinder 24 in the upward direction of the aircraft body. At this time, the claw 26 moves while hooking on the hook sections 25. As shown in the view, the hook sections 25 is configured of substantially horizontal surfaces to downward slopes and thereby the inner cylinder 27 slides easily in the upward direction within the outer cylinder 24. However, it is locked to restrict the movement thereof in the downward direction. As the result, the survival tub 1 also moves in the upward direction and thereby an increase in the crash stroke can be achieved.

After that, when a force that moves in the downward direction is applied to the survival tub 1 with the inertial force by the occupant 51 seated, the saucer section 30 pushes the plastic deformation absorbing body 29 of the inner cylinder 27, progressive plastic deformation progresses sequentially from the front end thereof at the plastic deformation absorbing body 29 and absorption of the energy is performed so that acceleration acting on the occupant can be reduced.

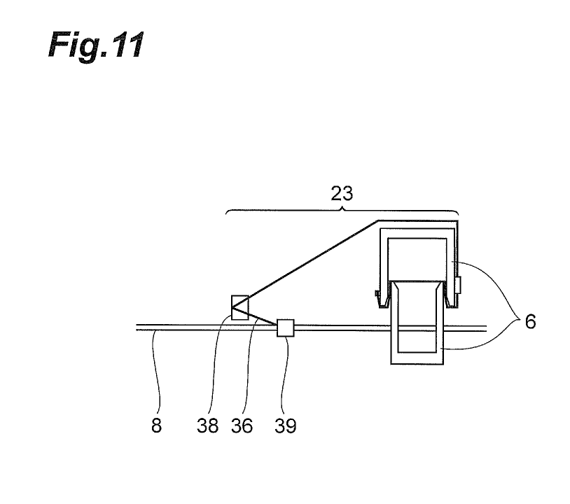

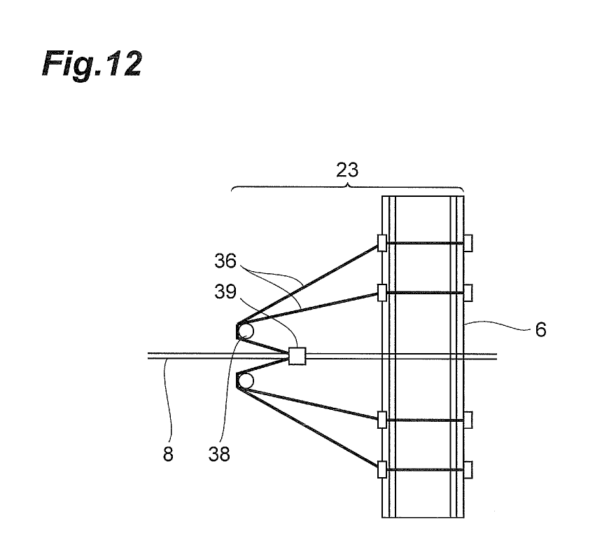

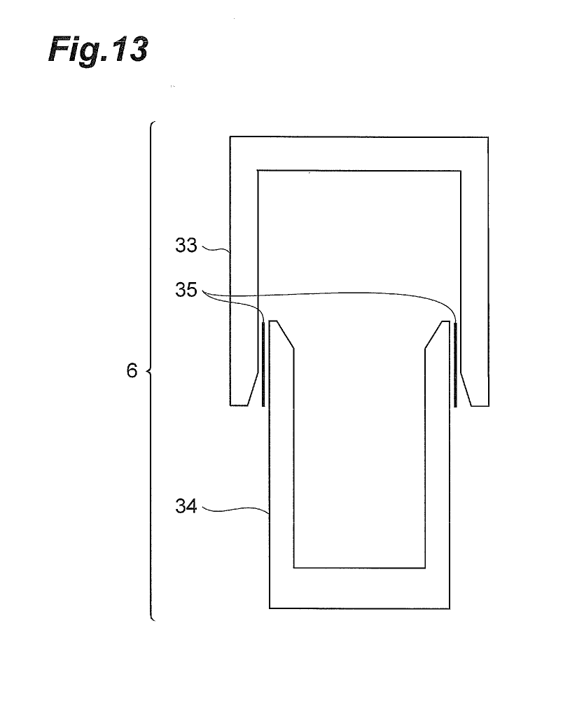

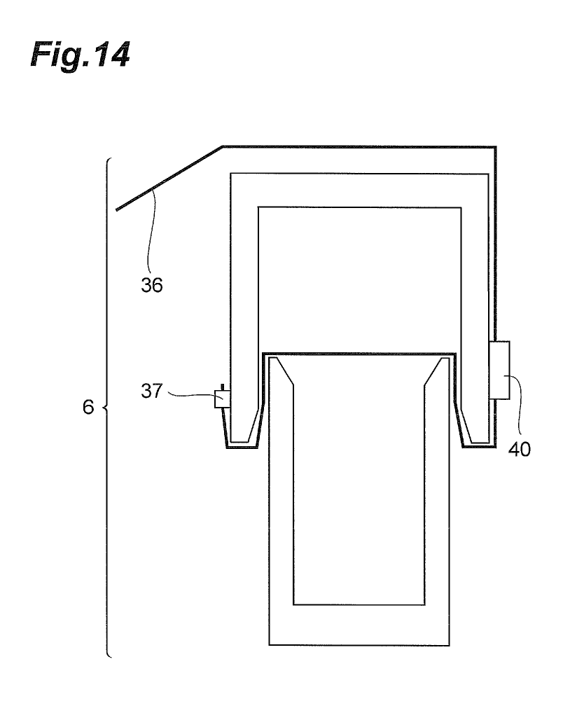

In order to further increase the moving stroke of the survival tub 1 in the downward direction, the crushing section 23 of the main spar of the main wing which separates the periphery of a connection portion of the main spar 6 of the main wing with the load transmission section 8 may be provided. FIG. 11 is a cross-sectional view showing a configuration of the crushing section 23 of the main spar of the main wing, FIG. 12 is a view of the section seen from above, and FIGS. 13 and 14 are cross-sectional views of the portion of the main spar 6 of the main wing. These are examples of a case where the load transmission section 8 is a mechanical type.

The main spar 6 of the main wing has a box type structure including an upper spar 33 having a square U-shaped cross-section, a lower spar 34 having the same square U-shaped cross-section and an adhesive layer 35. The width of an outer wall of a groove portion of the lower spar 34 is narrower than a width of a groove-shaped opening of the upper spar 33 and the openings thereof face each other and the upper spar 33 is overlapped to cover the groove of the lower spar 34 and thereby the overlapped portions thereof are bonded together by adhesive layer 35. The overlapped portion between the upper spar 33 and the lower spar 34 does not reach the lower side (the upper side of the inner wall surface of the upper spar 33) of the outer wall of the lower spar 34, but is arranged to overlap at the front end portions of both spars.

The main spar 6 is configured such that a wire 36 is arranged with predetermined intervals in its longitudinal direction. Specifically, an end of the wire 36 is fixed at a wire fixing section 37 provided at the lower end of the outer wall of the upper spar 33 in the aircraft nose side. The wire 36 passes through the overlapped portions (including inside the space formed between both spars) between the upper spar 33 and the lower spar 34, penetrates a stopper 40 arranged at the outer wall of the upper spar 33 in the rear side of the aircraft body, and turns over the upper surface of the upper spar 33. After that, the wire is dragged to the aircraft nose side and changes the direction thereof to the rear side of the aircraft body through a reel-shaped direction conversion pin 38, and is connected to the load transmission section 8 by a fixing section 39. In this configuration, each wire 36 is usually stretched with some degree of slack.

When the load transmission section 8 is displaced backwards due to the landing impact, each wire 36 is pulled and the tension may be provided with a delayed time by the slack mentioned above. The adhesive layer 35 is peeled off by the tension of the wire 36, and the upper spar 33 and the lower spar 34 of the center portion (surrounding range of the body) of the main spar 6 of the main wing are separated. The adhesive layer 35 is strong in the sharing direction, while the strength of the direction of peeling off to open the adhesive surface is significantly low, and thus the adhesive layer can be peeled off with a low load.

After that, when the wire 36 is further pulled, the fixing section 39 of the wire 36 stops at the stopper 40 portion apart from the outer wall of the aircraft nose of the upper spar 33. At this time, the wire 36 turns around on the upper side of the upper spar 33 and thereby the upper spar 33 is pushed downward with the tension that is applied to the wire 36. As the result, the main spar 6 is compressed in the vertical direction of the aircraft body and the upper space of the main spar 6 is expanded and thereby the amount of the downward moving stroke of the survival tub 1 can be increased. As the result, the acceleration (strictly speaking, deceleration) acting on occupants 51 in the vertical direction can be reduced.

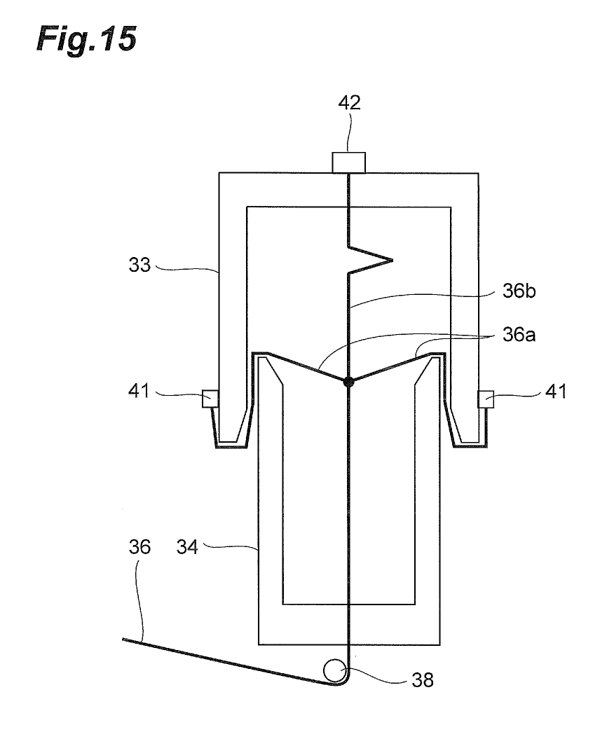

The arrangement example of the wire 36 is not limited to the embodiment described above. As shown in FIG. 15, the wire 36 penetrates the lower spar 34 and may branch to a wire 36a which is fixed to a fixing section 41 of both lower ends of the outer wall of the upper spar 33 and a wire 36b which penetrates the upper spar 33 with a predetermined degree of slack and is fixed by a fixing section 42 of the outer wall surface on the upper spar.

In the arrangement example described above, when the wire 36 is pulled by the collision load, first, the wire 36a is pulled inward and the adhesion layer 35 is peeled off similarly to the case described above, and the upper spar 33 and the lower spar 34 are separated. Furthermore, when the tension increases, the slack in the wire 36b disappears and the upper spar 33 is pulled downwardly and thereby the length of the main spar 6 of the main wing is compressed in the vertical direction of the aircraft body.

If the load transmission section 8 is the hydraulic type, an expandable bag which is formed from rubber or the like may be arranged inside the adhesive section 35 and during a collision, the bag is expanded and thereby the adhesive section is peeled off. After that, the upper spar 33 is pulled down using a hydraulic actuator or the like.

If the load transmission section 8 is an electric type, small amounts of explosives are arranged in several places inside the adhesion section 35 and the explosives are exploded similarly to the operation of air bag 11 and thereby the adhesive section 35 is peeled off. The peripheral position crossing the side surface of the body of the upper spar 33 is separated with a similar technique described above and thereby the entire upper spar 33 of the body portion may be separated. In this case, a mechanism which pushes down the separated upper spar 33 is not specifically required, and when the survival tub 1 is pushed downwardly, the upper spar 33 becomes as if it is pushed downwardly without resistance and an increase in the downward moving stroke of the survival tub 1 can be achieved.

The embodiments described above, exemplified respectively, can be properly changed and combined. In addition, the combination of mechanical, hydraulic and electric types is also possible.

### REFERENCE SIGNS LIST

1 . . . survival tub, 2 . . . firewall, 3 . . . aircraft nose structure member, 4 . . . pivot, 5 . . . link bracket, 6 . . . main spar of main wing, 7 . . . collision detection section, 8 . . . load transmission section, 9 . . . impact absorption operation section, 10 . . . operation installation section, 11 . . . air bag, 12 . . . bead, 13 . . . rib, 14 . . . EA structure, 15 . . . aircraft body frame, 16 . . . sliding vertical wall, 17 . . . sliding plate, 18 . . . multilayered plate, 19 . . . sliding film, 21 . . . load direction conversion tube, 22 . . . distribution link mechanism, 23 . . . crushing section of main spar of main wing, 24 . . . outer cylinder, 25 . . . hook section, 26 . . . claw, 27 . . . inner cylinder, 28 . . . operating axis section, 29 . . . plastic deformation absorbing body, 30 . . . saucer section, 31 . . . support guide, 33 . . . upper spar, 34 . . . lower spar, 35 . . . adhesive layer, 36 . . . wire, 37 . . . wire fixing section, 38 . . . direction conversion pin, 39 . . . fixing section, 40 . . . stopper, 41,42 . . . fixing section, 50 . . . seat, 51 . . . occupant, 100 . . . upper outer-shell, 101 . . . lower outer-shell.

1. A structure for an aircraft seat section comprising:
an occupant protection member which accommodates and fixes inside a seat in an upper space thereof, covers an occupant space including the seat from a lower side of the aircraft body, and is fixed to the aircraft body to be movable with respect to the aircraft body during impact of the aircraft body.

2. The structure for the aircraft seat section according to claim 1, further comprising moving means which moves the occupant protection member to an upper side of the aircraft body during impact.

3. The structure for the aircraft seat section according to claim 2,
wherein the moving means includes support means which supports a front side of the aircraft body of the occupant protection member to be rotatable about an axis substantially parallel with a left and right axis of the aircraft body as a centre, and stretching means which holds a rear side of the aircraft body of the occupant protection member to be movable in the vertical direction of the aircraft body.

4. The structure for the aircraft seat section according to claim 3,
wherein the stretching means absorbs the impact through a process of contraction.

5. The structure for the aircraft seat section according to claim 1, further comprising: a vertical wall which is arranged at an end of the occupant protection member in a width direction of the aircraft body; and an impact absorption member which is arranged at a side portion of the aircraft body adjacent to the vertical wall.

6. The structure for the aircraft seat section according to claim 1, further comprising: an aircraft body structure member which is arranged to connect to the lower side of the aircraft body of the occupant protection member; and changing means which changes a length of the aircraft body structure member in the vertical direction of the aircraft body.

7. The structure for the aircraft seat section according to claim 2, further comprising: a vertical wall which is arranged at an end of the occupant protection member in a width direction of the aircraft body; and an impact absorption member which is arranged at a side portion of the aircraft body adjacent to the vertical wall.

8. The structure for the aircraft seat section according to claim 3, further comprising: a vertical wall which is arranged at an end of the occupant protection member in a width direction of the aircraft body; and an impact absorption member which is arranged at a side portion of the aircraft body adjacent to the vertical wall.

9. The structure for the aircraft seat section according to claim 4, further comprising: a vertical wall which is arranged at an end of the occupant protection member in a width direction of the aircraft body; and an impact absorption member which is arranged at a side portion of the aircraft body adjacent to the vertical wall.

10. The structure for the aircraft seat section according to claim 2, further comprising: an aircraft body structure member which is arranged to connect to the lower side of the aircraft body of the occupant protection member; and changing means which changes a length of the aircraft body structure member in the vertical direction of the aircraft body.

11. The structure for the aircraft seat section according to claim 3, further comprising: an aircraft body structure member which is arranged to connect to the lower side of the aircraft body of the occupant protection member; and changing means which changes a length of the aircraft body structure member in the vertical direction of the aircraft body.

12. The structure for the aircraft seat section according to claim 4, further comprising: an aircraft body structure member which is arranged to connect to the lower side of the aircraft body of the occupant protection member; and changing means which changes a length of the aircraft body structure member in the vertical direction of the aircraft body.

13. The structure for the aircraft seat section according to claim 5, further comprising: an aircraft body structure member which is arranged to connect to the lower side of the aircraft body of the occupant protection member; and changing means which changes a length of the aircraft body structure member in the vertical direction of the aircraft body.

14. The structure for the aircraft seat section according to claim 7, further comprising: an aircraft body structure member which is arranged to connect to the lower side of the aircraft body of the occupant protection member; and changing means which changes a length of the aircraft body structure member in the vertical direction of the aircraft body.

15. The structure for the aircraft seat section according to claim 8, further comprising: an aircraft body structure member which is arranged to connect to the lower side of the aircraft body of the occupant protection member; and changing means which changes a length of the aircraft body structure member in the vertical direction of the aircraft body.

16. The structure for the aircraft seat section according to claim 9, further comprising: an aircraft body structure member which is arranged to connect to the lower side of the aircraft body of the occupant protection member; and changing means which changes a length of the aircraft body structure member in the vertical direction of the aircraft body.
